(19) United States
(12) Patent Application Publication
(10) Pub. No.: US 2009/0000411 A1
(43) Pub. Date: Jan. 1, 2009

(54) Shift range change apparatus

(75) Inventors: Seiji Nakayama, Obu-city (JP); Kiyoshi Kimura, Obu-city (JP); Taku Itoh, Chita-gun (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/213,827

(22) Filed: Jun. 25, 2008

(30) Foreign Application Priority Data
Jun. 27, 2007 (JP) 2007-169460

(51) Int. Cl. F16H 61/00; B60W 10/10

(52) U.S. Cl. 74/335; 477/94; 74/473.21; 74/473.12

(57) ABSTRACT

A shift range change mechanism changes a shift range of an automatic transmission of a vehicle. A parking change mechanism disables rotation of a drive axle of the vehicle by engaging a park pole supported by a stationary member against a parking gear, which is rotated synchronously with the drive axle of the vehicle, at time of setting the shift range to parking. The parking change mechanism enables the rotation of the drive axle by disengaging the park pole from the parking gear at time of parking release of the shift range. An electric rotatable actuator drives the shift range change mechanism and the parking change mechanism. An SBW ECU controls power supply to an electric motor of the rotatable actuator. The SBW ECU increases an output torque of the electric motor only at the time of the parking release.

### CROSS REFERENCE TO RELATED APPLICATION

This application is based on and incorporates herein by reference Japanese Patent Application No. 2007-169460 filed on Jun. 27, 2007.

### BACKGROUND OF THE INVENTION

1. Field of the Invention

The present invention relates to a shift range change apparatus having a shift range change mechanism and a parking change mechanism.

2. Description of Related Art

An automatic transmission of a vehicle includes a shift range change mechanism and a parking change mechanism and is shifted manually by a driver of the vehicle. However, lately, a shift range change apparatus (a shift-by-wire abbreviated as “SBW”), which changes the shift range change mechanism and the parking change mechanism through a rotatable actuator having an electric motor, is prevailing in the market.

In general, the vehicle is designed on the assumption that the vehicle is used in various conditions. Thereby, the vehicle is designed to be parked on a slope (a sloping road).

At the time of parking the vehicle on the slope, the gravitational force, which acts on the vehicle to move the vehicle, is applied, through an axle of the vehicle, to an engaged part of the parking change mechanism (specifically, an engaged part between a parking gear and a park pole) and also between the park pole and a park rod. This force is increased proportional to the tilt angle of the slope. In view of this, the rotatable actuator (the SBW actuator) is set to generate a large output torque to smoothly release the engagement of the parking change mechanism at the time of parking release (time of changing P to notP), at which the engagement of the parking change mechanism is released, even in the parked state of the vehicle on the slope.

As described above, the rotatable actuator is set to generate the large torque, which is required at the time of the parking release on the slope.

However, when the rotatable actuator is always operated at the maximum torque, the following disadvantages are encountered.

(I) According to a previously known technique, in a case where a reference position of the electric motor of the rotatable actuator is unknown at the time of starting the operation, or in a case where a set position of the shift is unknown at the time of starting the operation, an abutment control operation is executed to rotate a rotor until occurrence of abutment at an extreme limit position (a parking side movable limit position) in a movable range of the shift range change mechanism. Then, the position, at which the rotation of the rotor is stopped, is set as a reference position in the rotation control operation of the rotor (or a reference position in the shift change control operation).

In the case where the abutment control operation is executed upon generation of the large torque from the electric motor, when the movable member abuts against the stationary member, a mechanical collision load is generated. When the number of times of executing the abutment control operation is increased, a mechanical damage may possibly occur.

(II) When the rotation is stopped in the state where the electric power is supplied to the electric motor, the large mechanical load torque may be applied to the components in the rotation transmission system as well as the engaged part between the movable member and the stationary member. Upon the long time use, the mechanical damage may possibly occur on them.

(III) The power consumption of the electric motor is increased to generate the large output torque from the electric motor. Specifically, the large output torque is generated even in the state where the large torque is not required, so that the electric power is consumed wastefully. Furthermore, when the large electric current is supplied to the electric motor to always generate the large output torque, the amount of heat generation at the coils of the electric motor is disadvantageously increased.

A technique (see, for example, Japanese Unexamined Patent Publication No. 2006-191709 corresponding to US 2006/0138880) has been proposed to reduce the output torque of the electric motor at the time of executing the abutment control operation through a current limiter circuit, a limiter circuit of an exciting device and a duty ratio control.

However, even when the technique of Japanese Unexamined Patent Publication No. 2006-191709 corresponding to US 2006/0138880 is used, the disadvantages recited in the above sections (II) and (III) cannot be addressed due to the generation of the large output torque from the electric motor at the time of the other operation (except the time of the abutment control operation), which is other than the parking release and does not require the large torque.

### SUMMARY OF THE INVENTION

The present invention addresses one or more the above disadvantages. According to the present invention, there is provided a shift range change apparatus, which includes a shift range change mechanism, a parking change mechanism, an electric rotatable actuator and a motor control means. The shift range change mechanism changes a shift range of an automatic transmission of a vehicle. The parking change mechanism disables rotation of a drive axle of the vehicle by engaging a park pole supported by a stationary member against a parking gear, which is rotated synchronously with the drive axle of the vehicle, at time of setting the shift range to parking. The parking change mechanism enables the rotation of the drive axle by disengaging the park pole from the parking gear at time of parking release of the shift range. The electric rotatable actuator drives the shift range change mechanism and the parking change mechanism. The motor control means is for controlling power supply to an electric motor of the rotatable actuator. The motor control means includes a torque increasing means for increasing an output torque of the electric motor only at the time of the parking release.

### BRIEF DESCRIPTION OF THE DRAWINGS

FIG. 1 is a schematic diagram showing a shift range change apparatus having a parking change mechanism and a shift range change mechanism according to a first embodiment of the present invention;

FIG. 2 is a cross sectional view of a rotatable actuator according to the first embodiment;

FIG. 3 is a schematic diagram showing a structure of the shift range change apparatus according to the first embodiment;

FIG. 4 is a schematic diagram showing an electric motor according to the first embodiment;

FIG. 5 is a circuit diagram of the electric motor according to the first embodiment;

FIG. 6 is a perspective view of a speed reducer taken from a front side thereof according to the first embodiment;

FIG. 7A is a diagram showing a power supply state of exciting coils of the electric motor at time of parking release according to the first embodiment;

FIG. 7B is a diagram showing another power supply state of the exciting coils of the electric motor at time of other operation, which is other than the parking release according to the first embodiment;

FIG. 8 is a diagram showing a power supply state of the exciting coils of the electric motor at the time of the other operation, which is other than the parking release in a modification of the first embodiment;

FIG. 9 is a schematic diagram showing a shift range change apparatus having a parking change mechanism and a shift range change mechanism according to a second embodiment of the present invention; and

FIG. 10 is a schematic diagram showing a shift range change apparatus having a parking change mechanism and a shift range change mechanism according to a third embodiment of the present invention.

### DETAILED DESCRIPTION OF THE INVENTION

### First Embodiment

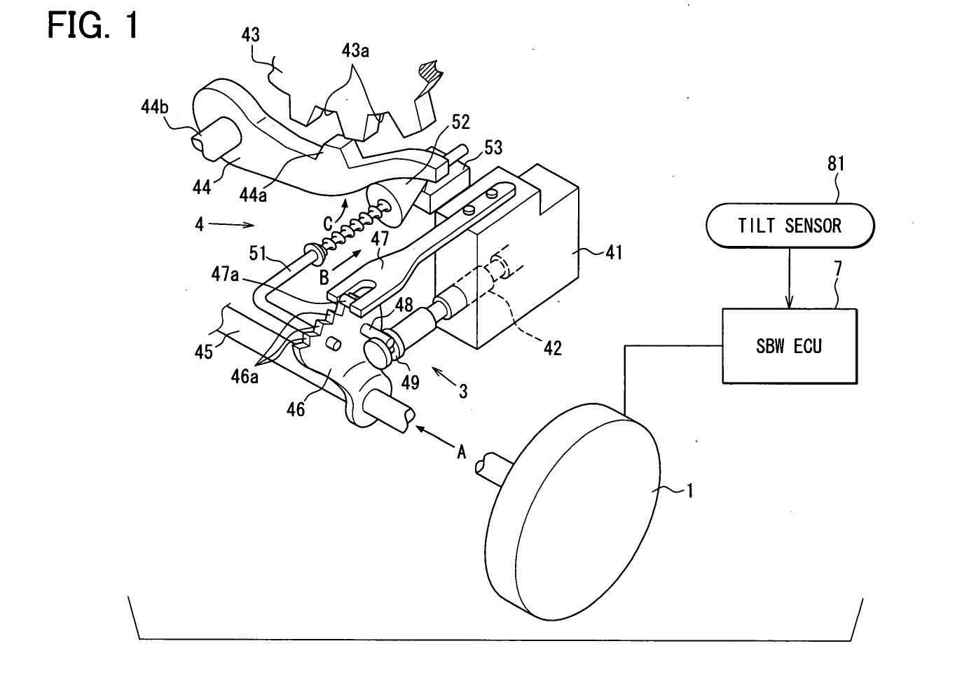

A shift range change apparatus according to a first embodiment of the present invention will be described with reference to FIGS. 1 to 8.

With reference to FIGS. 1 to 3, in the shift range change apparatus, a rotatable actuator 1 is used to change, i.e., shift a shift range change mechanism 3 and a parking change mechanism 4 installed in a vehicle automatic transmission 2.

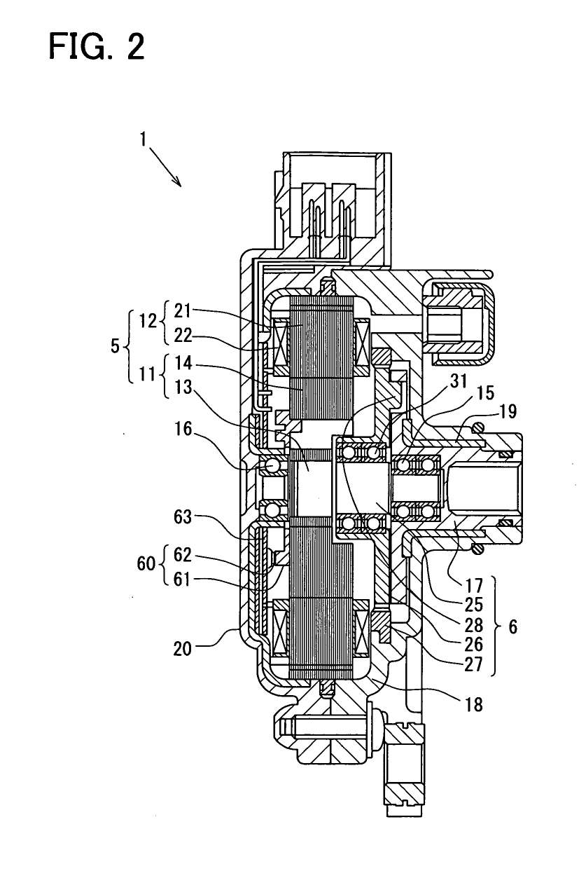

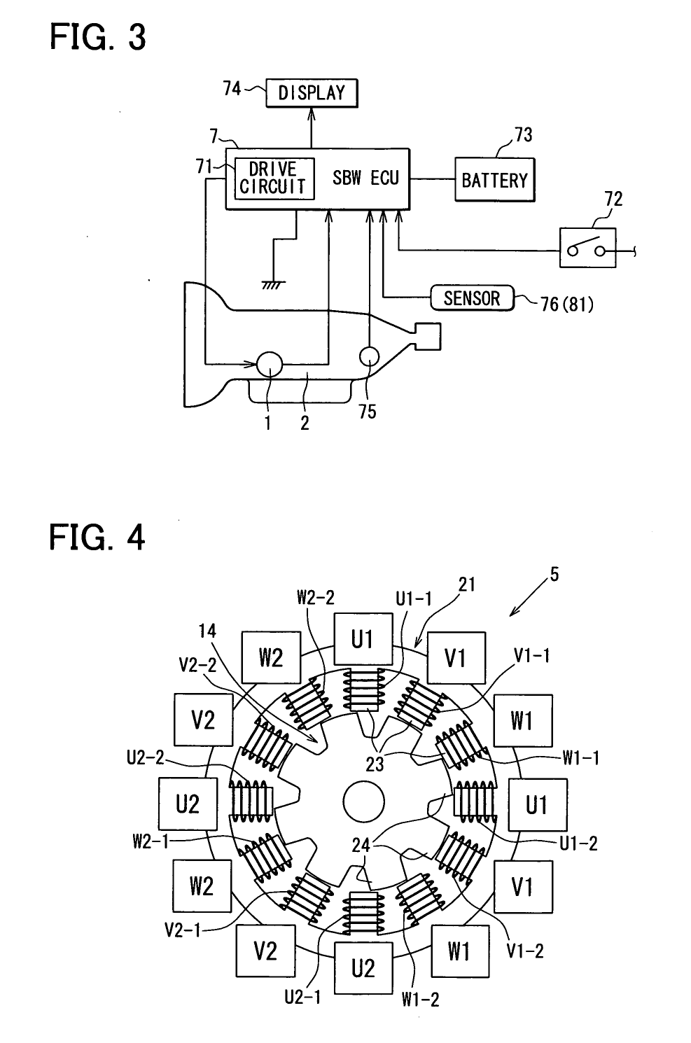

The rotatable actuator 1 is a servo mechanism, which drives the shift range change mechanism 3. As shown in FIG. 2, the rotatable actuator 1 includes a synchronous electric motor 5 and a speed reducer 6. The speed reducer 6 reduces a rotational speed of rotation of the motor 5 and outputs the rotation of the reduced speed. As shown in FIG. 3, the rotation of the motor 5 is controlled by a shift-by-wire electronic control unit (SBW ECU) 7, which serves as a motor controlling means.

Specifically, the shift range change apparatus controls the shift range change mechanism 3 and the parking change mechanism 4, which are driven through the speed reducer 6, by controlling a rotational direction, the number of rotations per unit time and a rotational angle of the motor 5 through the SBW ECU 7.

Next, the structure of the shift range change apparatus will be described in detail. In the following description, a right side and a left side of FIG. 2 correspond to a front side and a rear side, respectively, of the rotatable actuator 1. However, it should be noted that these terms, i.e., the front side and the rear side are merely used for the descriptive purpose and are not related to an actual installation direction of the rotatable actuator 1.

Now, the motor 5 will be described with reference to FIGS. 2 and 4.

The motor 5 of the first embodiment is a brushless switched reluctance (SR) motor and includes a rotor 11 and a stator 12. The rotor 11 is rotatably supported, and the stator 12 is coaxial with the rotor 11.

The rotor 11 includes a rotor shaft 13 and a rotor core 14. The rotor shaft 13 is rotatably supported by two bearings (i.e., a front rolling bearing 15 and a rear rolling bearing 16), which are provided at a front end and a rear end, respectively, of the rotor shaft 13.

The front rolling bearing 15 is securely fitted to an inner peripheral surface of an output shaft 17 of the speed reducer 6. The output shaft 17 of the speed reducer 6 is rotatably supported by a metal bearing 19, which is held by an inner peripheral surface of a front housing 18. Specifically, the front end of the rotor shaft 13 is rotatably supported by the front rolling bearing 15 that is supported by the output shaft 17, which is in turn supported by the metal bearing 19 provided in the front housing 18.

An axial support range of the metal bearing 19 is set to overlap with an axial support range of the front rolling bearing 15. In this way, tilting of the rotor shaft 13, which would be caused by a reaction force of the speed reducer 6 (specifically, a reaction force of a load caused by engagement between a sun gear 26 and a ring gear 27 described below).

The rear rolling bearing 16 is supported by a rear housing 20 (a stator housing), which is securely press fitted to an outer peripheral surface of the rear end of the rotor shaft 13.

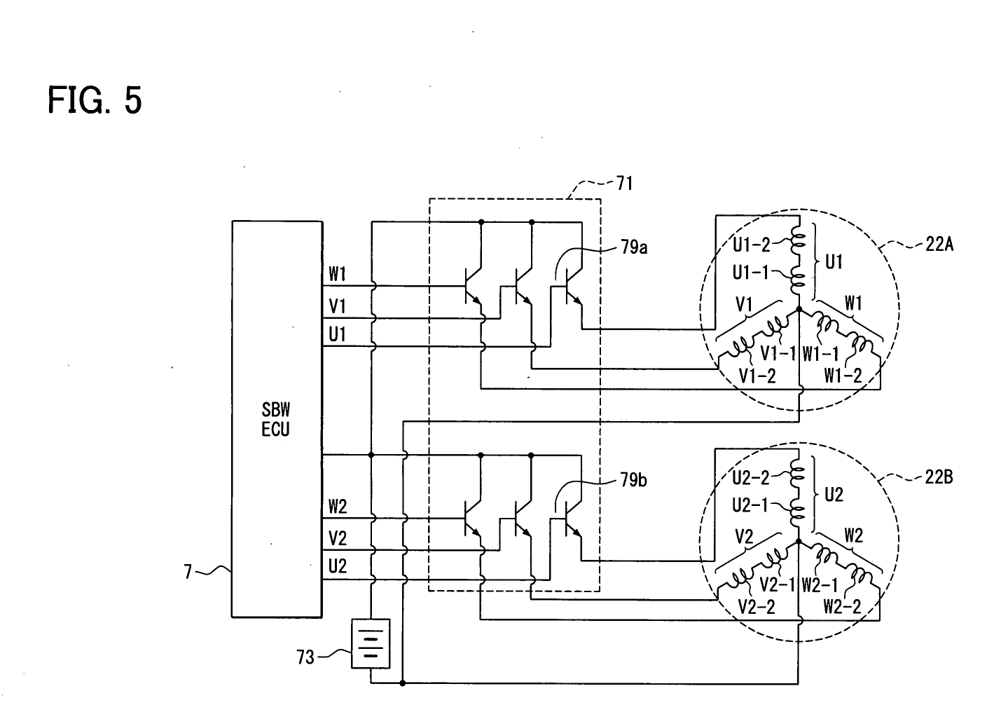

The stator 12 includes exciting coils 22 of multiple phases (specifically, coils U1, V1, W1 of a first system 22A, and coils U2, V2, W2 of a second system 22B shown in FIGS. 4 and 5), which generate a magnetic force upon energization thereof in corporation with a fixed stator core 21.

The stator core 21 is formed by stacking a plurality of thin plates and is fixed to the rear housing 20. The stator core 21 includes a plurality of stator teeth 23 (radially inwardly projecting salient poles), which radially inwardly project toward the rotor core 14 and are arranged one after another at about 30 degree intervals in a rotational direction (a circumferential direction). The coils U1, V1, W1 of the first system 22A and the coils U2, V2, W2 of the second system 22B are wound around the corresponding stator teeth 23 to generate a magnetic force at the respective stator teeth 23. Here, the coils U1, U2 are of a U phase, and the coils V1, V2 are of a V phase. Furthermore, the coils W1, W2 are of a W phase.

Now, the exciting coils 22 will be described with reference to FIGS. 4 and 5 in detail.

As shown in FIG. 5, the coils U1, V1, W1 of the first system 22A are wound electrically independently from the coils U2, V2, W2 of the second system 22B such that the coils U1, V1, W1 of the first system 22A are connected together to form a corresponding star connection, and the coils U2, V2, W2 of the second system 22B are connected together to form a corresponding star connection. Due to the following construction, the coils U1, V1, W1 of the first system 22A are capable driving the rotor 11 upon energization thereof, and similarly the coils U2, V2, W2 of the second system 22B are capable of driving the rotor 11 upon energization thereof.

Each of the coils U1, V1, W1 of the first system 22A is divided into a plurality of parts (two parts in this embodiment), which are wound separately from one another, and similarly each of the coils U2, V2, W2 is divided into a plurality of parts (two parts in this embodiment), which are wound separately from one another.

Specifically, the coils U1, V1, W1 of the first system 22A include a first group of coils U1-1, V1-1, W1-1 and a second group of coils U1-2, V1-2, W1-2. Here, the coils U1-1, V1-1, W1-1 in the first group are installed to the corresponding stator teeth 23, respectively, which are arranged one after another in the rotational direction, and the coils U1-2, V1-2, W1-2 in the second group are installed to the corresponding subsequent stator teeth 23, respectively, which are arranged one after another in the rotational direction after the first group.

Furthermore, the coils U2, V2, W2 of the second system 22B include a first group of coils U2-1, V2-1, W2-1 and a second group of coils U2-2, V2-2, W2-2. Here, the coils U2-1, V2-1, W2-1 in the first group are installed to the corresponding stator teeth 23, respectively, which are arranged one after another in the rotational direction, and the coils U2-2, V2-2, W2-2 in the second group are installed to the corresponding subsequent stator teeth 23, respectively, which are arranged one after another in the rotational direction after the first group.

When the respective exciting coils 22 are energized, two opposite polarities are created in the first and second groups, respectively. Specifically, in the case where an N-pole is created at the radial inner ends of the coils U1-1, V1-1, W1-1 of the first group of the first system 22A, an S-pole is created at the radial inner ends of the coils U1-2, V1-2, W1-2 of the second group of the first system 22A, which are placed adjacent to the coils U1-1, V1-1, W1-1 of the first group. Furthermore, an N-pole is created at the radial inner ends of the coils U2-1, V2-1, W2-1 of the first group of the second system 22B, which are placed adjacent to the coils U1-2, V1-2, W1-2 of the second group of the first system 22A. In addition, an S-pole is created at the radial inner ends of the coils U2-2, V2-2, W2-2 of the second group of the second system 22B, which are placed adjacent to the coils U2-1, V2-1, W2-1 of the first group of the second system 22B.

In this way, for example, when the two coils U1-1, U1-2 of the coil U1 of the U phase are energized, the N-pole and the S-pole are created at the corresponding two stator teeth 23, respectively, to which the coils U1-1, U1-2 are respectively installed, and which are displaced from one another by about 90 degrees in the rotational direction. In each of the other remaining coils V1, W1, U2, V2, W2 of the remaining phases, the opposite poles (i.e., the N-pole and the S-pole) are created at the corresponding stator teeth 23, which are displaced from one another by about 90 degrees in the manner similar to those of the coils U1-1, U1-2 of the coil U1 of the U phase.

The rotor core 14 is formed by stacking a plurality of thin plates and is securely press fitted to the rotor shaft 13. The rotor core 14 includes rotor teeth 24 (radially outwardly projecting salient poles), which radially outwardly project toward the stator core 21 and are arranged one after another at about 45 degree intervals in the rotational direction (the circumferential direction).

The location and the direction of the power supply of the exciting coils 22 of the U phase, the V phase and the W phase are sequentially changed to sequentially change the active stator teeth 23, which magnetically attract the rotor teeth 24, so that the rotor 11 is rotated in one direction or the other direction.

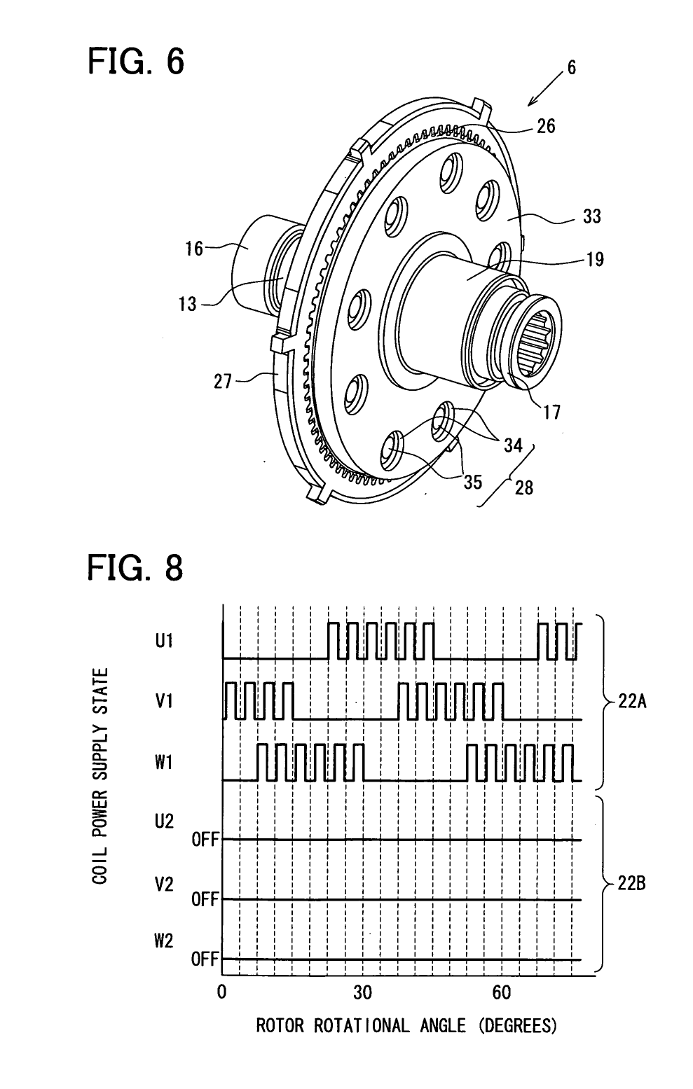

Next, the speed reducer 6 will be described with reference to FIGS. 2 and 6.

The speed reducer 6 of the first embodiment is an inner gearing planetary gear speed reducer (a cycloid speed reducer), which is one of various types of planetary speed reducers. The speed reducer 6 includes the sun gear 26 (inner gear: externally toothed gear), the ring gear 27 (outer gear: internally toothed gear) and a transmitting device or arrangement (a transmitting means) 28. The sun gear 26 is eccentrically rotatably installed to the rotor shaft 13 through an eccentric portion 25, which is provided to the rotor shaft 13. The ring gear 27 is meshed with the sun gar 26, which is located radially inward of the ring gear 27. The transmitting device 28 transmits only a rotational force component of the sun gear 26 to the output shaft 17.

The eccentric portion 25 is a shaft, which is eccentrically rotated about a rotational center of the rotor shaft 13 to cause swing rotation of the sun gear 26. The eccentric portion 25 rotatably supports the sun gear 26 through a sun gear bearing 31, which is positioned radially outward of the eccentric portion 25.

As described above, the sun gear 26 is rotatably supported by the eccentric portion 25 of the rotor shaft 13 through the sun gear bearing 31. When the eccentric portion 25 is rotated, the sun gear 26 is rotated while being urged against the ring gear 27.

The ring gear 27 is fixed to the front housing 18.

The transmitting device 28 includes a plurality of inner pin holes 34 and a plurality of inner pins 35. The inner pin holes 34 are arranged one after another along a common imaginary circle on a flange 33, which rotates integrally with the output shaft 17. The inner pins 35 are formed in the sun gear 26 and are loosely fitted into the inner pin holes 34, respectively.

The inner pins 35 project from a front surface of the sun gear 26.

The inner pin holes 34 are formed in the flange 33, which is provided at the rear end of the output shaft 17. The rotation of the sun gear 26 is transmitted to the output shaft 17 through the engagement between the inner pins 35 and the corresponding inner pin holes 34.

With the above construction, when the rotor shaft 13 is rotated to eccentrically rotate the sun gear 26, the sun gear 26 is rotated at the reduced rotational speed, which is lower than that of the rotor shaft 13. Then, the rotation of the sun gear 26 at the reduced rotational speed is transmitted to the output shaft 17. The output shaft 17 is connected to a control rod 45 (described latter) of the shift range change mechanism 3.

Alternative to the above described construction of the first embodiment, the inner pin holes 34 may be formed in the sun gear 26, and the inner pins 35 may be provided in the flange 33.

The shift range change mechanism 3 and the parking change mechanism 4 are driven to change its operational position by the output shaft of the rotatable actuator 1 (specifically, the output shaft 17 of the speed reducer 6).

In the shift range change mechanism 3, a manual spool valve 42, which is provided in a hydraulic valve body 41, is slid and is thereby changed to a corresponding position, which corresponds to the instructed shift range, so that a hydraulic pressure supply passage, which supplies a hydraulic pressure to each corresponding hydraulic clutch (not shown) of the automatic transmission 2, is changed to control an engaged/disengaged state of the hydraulic clutches.

In the parking change mechanism 4, a park pole 44, which is rotatably supported by an undepicted stationary member (e.g., a housing of the automatic transmission 2), is engaged with and disengaged from a parking gear 43, which is rotated synchronously with a drive axle of the vehicle to change the operational state of the parking gear 43 between an locked state (a parking state) and an unlocked state (a parking released state). Specifically, the parking change mechanism 4 is changed between the locked state and the unlocked state through engagement and disengagement between a corresponding recess 43a of the parking gear 43 and a protrusion 44a of the park pole 44. When the rotation of the parking gear 43 is limited, i.e., is disabled, driving wheels of the vehicle are locked through the drive axle and a differential gear. Thereby, the vehicle is placed in the parking state.

A generally fan shaped detent plate 46 is fixed to the control rod 45 by, for example, a spring pin (not shown). The control rod 45 is driven by the speed reducer 6.

A plurality of recesses 46a is provided in a radially outer end (a generally fan shaped outer arcuate portion) of the detent plate 46. When an engaging portion 47a at a distal end of a detent spring 47, which is fixed to the hydraulic valve body 41, is engaged with the corresponding recess 46a, the current shift range is maintained. In the present embodiment, the detent spring 47 is formed as a leaf spring and serves as a detent mechanism. However, the present invention is not limited to this detent mechanism, and any other suitable detent mechanism may be alternatively used. For example, a coil spring may be used to urge the engaging portion 47a against a bottom of the corresponding recess 46a.

A pin 48, which drives the manual spool valve 42, is fixed to the detent plate 46.

The pin 48 is engaged with an annular groove 49, which is formed in an end of the manual spool valve 42. When the detent plate 46 is rotated by the control rod 45, the pin 48 is driven along an arcuate path. Thus, the manual spool valve 42, which is engaged with the pin 48, is moved linearly in an interior of the hydraulic valve body 41.

In a view taken in a direction of an arrow A in FIG. 1, when the control rod 45 is rotated in a clockwise direction, the pin 48 is driven in the clockwise direction through the detent plate 46. Thus, the pin 48 pushes the manual spool valve 42 toward the interior of the hydraulic valve body 41 to sequentially change an active hydraulic fluid passage in the hydraulic valve body 41 in an order of a hydraulic fluid passage of a D range, a hydraulic fluid passage of an N range, a hydraulic fluid passage of an R range and a hydraulic fluid passage of a P range. Thus, the shift range of the automatic transmission 2 is changed in the order of the D range, the N range, the R range and the P range.

On the other hand, when the control rod 45 is rotated in the reverse direction (counterclockwise direction), the pin 48 pulls the manual spool valve 42 away from the hydraulic valve body 41 to change the active hydraulic fluid passage in the hydraulic valve body 41 in an order of the hydraulic fluid passage of the P range, the hydraulic fluid passage of the R range, the hydraulic fluid passage of the N range and the hydraulic fluid passage of the D range. Thus, the shift range of the automatic transmission 2 is changed in the order of the P range, the R range, the N range and the D range.

A park rod 51 is fixed to the detent plate 46 to drive the park pole 44. A conical portion 52 is provided in a distal end of the park rod 51.

The conical portion 52 is interposed between a protruded portion 53 of the housing of the automatic transmission 2 and the park pole 44. In the view taken in the direction of the arrow A in FIG. 1, when the control rod 45 is rotated in the clockwise direction (specifically, from the R range to the P range), the park rod 51 is driven through the detent plate 46 in a direction of an arrow B in FIG. 1 to push up the park pole 44. Thus, the park pole 44 is rotated about a shaft 44b in a direction of an arrow C in FIG. 1. Therefore, the protrusion 44a of the park pole 44 is engaged with the opposed recess 43a of the parking gear 43 to achieve the locked state (the parking state) of the parking change mechanism 4.

When the control rod 45 is rotated in the opposite direction (specifically, from the P range to the R range), the park rod 51 is pulled back in an opposite direction, which is opposite from the direction of the arrow B in FIG. 1. Thus, the urging force, which pushes up the park pole 44, is removed. The park pole 44 is always urged by a coil spring (not shown) in an opposite direction, which is opposite from the direction of the arrow C in FIG. 1. Thus, the protrusion 44a of the park pole 44′ is pushed away from the opposed recess 43a of the parking gear 43 to release the parking gear 43 into a free state, and thereby the parking change mechanism 4 is placed into the unlocked state (the parking released state).

As shown in FIG. 2, the rotatable actuator 1 includes an encoder 60, which senses the rotational angle of the rotor 11 and is received in the housing (the front housing 18 and the rear housing 20) of the rotatable actuator 1. The rotational angle of the rotor 11 is sensed with the encoder 60, so that the motor 5 can be rotated at a high speed without losing the synchronism of the motor 5.

The encoder 60 is of an incremental type and includes a magnet 61 and Hall ICs 62. The magnet 61 is rotated integrally with the rotor 11. The Hall ICs 62 are arranged in the rear housing 20 to sense the magnetism generated from the magnet 61. The Hall ICs 62 are supported on a circuit board 63, which is received in the rear housing 20.

Next, the SBW ECU 7 will be described with reference to FIG. 3 in detail.

The SBW ECU 7, which control the power supply to the motor 5, has a microcomputer of a know type, which includes a CPU, a storage device (a memory, such as a ROM, an SRAM, an EEPROM, a RAM), an input circuit, an output circuit and a power supply circuit. The CPU performs various control operations and computing operations. The storage device stores various programs and data. A coil drive circuit 71 of the motor 5 is installed in a case, which receives the SBW ECU 7. Alternatively, as shown in FIG. 5, the coil drive circuit 71 may be installed outside of the case of the SBW ECU 7.

In FIG. 3, numeral 72 indicates a start switch (e.g., an ignition switch, an accessory switch), and numeral 73 indicates a vehicle battery. Furthermore, numeral 74 indicates a display device, which displays the state of the shift range change apparatus to an occupant of the vehicle. In addition, numeral 75 indicates a vehicle speed sensor, and numeral 76 indicates other sensors, which sense the state of the vehicle. These other sensors include a vehicle tilt sensor 81 (described latter) as well as a shift range sensor for sensing the shift range set by the occupant, a brake switch and the like.

The SBW ECU 7 is provided with various control programs, which implements functions of a rotor reading means, a normal control means and an abutment control means. The rotor reading means is for obtaining a rotational speed, a number of rotations per unit time and a rotational angle. The normal control means is for controlling the motor 5 to coincide a shift range position, which is recognized by the SBW ECU 7, with a position that is set through an undepicted shift range manipulator (a shift range manipulating means), which is manipulated by the occupant.

The normal control means executes the normal control operation. Specifically, the normal control means determines the rotational direction, the number of rotations per unit time and the rotational angle of the motor 5 based on the output of the shift range manipulator (the shift range manipulating means) manipulated by the occupant. Then, based on the determined result, the normal control means controls the power supply to the exciting coils 22 of the multiple phases to control the rotational direction, the number of rotations per unit time and the rotational angle of the motor 5. Specifically, at the time of rotating the motor 5, the SBW ECU 7 executes a synchronous operation, in which the power supply state of the exciting coils 22 of the multiple phases is changed based on, for example, the rotational angle of the rotor 11 that is sensed with the encoder 60 to control the rotational direction, the number of rotations per unit time and the rotational angle of the motor 5 and thereby controls the change in the shift range change mechanism 3 and the change in the parking change mechanism 4 through the speed reducer 6.

The abutment control means starts execution of the abutment control operation every time when the operation starts (every time when the start switch 72 is turned on), or every time when the start of the operation is repeated for a predetermined number of times, or when the set position of the shift at the time of starting the operation is unknown, or when a predetermined learning condition is satisfied. The abutment control means stops the abutment control operation when the abutment control operation is executed for a predetermined time period, or when the change in the rotational angle of the rotor 11, which is read from the encoder 60, stops for a predetermined time period, or when a reference position recognizing means recognizes (identifies) a reference position.

The abutment control operation is executed by executing a program that drives a movable member of the shift range change mechanism 3 to cause abutment of the movable member at one extreme limit position (e.g., a parking side movable limit position) in a movable range of the movable member.

Now, a background of the first embodiment will be described.

In general, the vehicle is designed on the assumption that the vehicle is used in various conditions. Thereby, the vehicle is designed to be parked on a slope (a sloping road).

At the time of parking the vehicle on the slope, the gravitational force, which acts on the vehicle to move the vehicle, is applied, through the axle of the vehicle, to the engaged part between the parking gear 43 and the park pole 44 and between the park pole 44 and the park rod 51 in the parking change mechanism 4. Thus, the motor 5 is provided at the rotatable actuator 1 to generate the force, which can smoothly release the engagement between the parking gear 43 and the park pole 44 by pulling the park rod 51 at the time of releasing the parking (time of changing from P to notP) even in the parked state of the vehicle on the slope.

Specifically, as discussed above, the motor 5 includes the first system 22A (the coils U1, V1, W1) and the second system 22B (the coils U2, V2, W2), which are electrically independent from each other. The coils U1, V1, W1 of the first system 22A are connected together to form the corresponding star connection, and the coils U2, V2, W2 of the second system 22B are connected together to form the corresponding star connection.

As shown in FIG. 5, the coil drive circuit 71 includes a first switching device 79a and a second switching device 79b. The first switching device 79a is arranged to provide the electric power to the respective phases (the respective coils U1, V1, W1) of the first system 22A, and the second switching device 79b is arranged to provide the electric power to the respective phases (the respective coils U2, V2, W2) of the second system 22B. When the SBW ECU 7 executes the turning on and turning off of the first switching device 79a and the second switching device 79b, the power supply state of the respective coils U1, V1, W1, U2, V2, W2 is changed.

The SBW ECU 7 controls the coil drive circuit 71 to simultaneously controls the power supply to the respective phases (the respective coils U1, V1, W1) of the first system 22A and the power supply to the respective phases (the respective coils U2, V2, W2) of the second system 22B, so that the motor 5 generates a relatively large output torque. Therefore, even at time of parking the vehicle on the slope, the force, which enables the smooth release of the engagement between the parking gear 43 and the park pole 44, is generated at the rotatable actuator 1.

However, when the rotatable actuator 1 is operated at the maximum torque, the following disadvantages may occur.

(1) When the abutment control operation is executed, the rotor 11 is rotated until the occurrence of the abutment at the one extreme limit position. Therefore, when the engaging portion 47a of the detent spring 47 abuts against a limit wall of the detent plate 46, a mechanical collision load is generated. In this embodiment, it should be noted that the limit wall of the detent plate 46 does not refer to a rigid actual physical wall. More likely, the limit wall of the detent plate 46 refers to an imaginary limit wall, which is supposed to exist at a location where the engaging portion 47a of the detent spring 47 is engaged to the corresponding recess 46a of the detent plate 46 and which limits further rotation of the detent plate 46. Furthermore, the output torque of the motor 5 drives the detent plate 46 to cause the abutment of the engaging portion 47a of the detent spring 47 against each of the limit walls provided at the ends, respectively, of the detent plate 46. Therefore, the output torque of the motor 5 causes application of the mechanical load on the components (e.g., the engaging portion 47a of the detent spring 47) in the rotation transmission system as well as the engaging part between the movable member and the stationary member.

Therefore, when the abutment control operation is executed in the state where the large output torque is generated at the motor 5, the mechanical collision load is generated at the time of the abutment of the movable member to the stationary member. When the number of executions of the abutment control operation is increased, the mechanical damage may possibly occur.

(2) In the case where the large output torque is generated by the motor 5, when the rotation is stopped while the motor 5 is still powered, the large mechanical load torque is applied to the components of the rotation transmission system as well as the engaging part between the movable member and the stationary member. Therefore, after the long time use, the mechanical damage may possibly occur.

(3) When the motor 5 generates the large output torque, the power consumption of the motor 5 becomes large. Specifically, the large output torque is generated even in the state where the large torque is not required, so that the electric power is consumed wastefully. Furthermore, the large electric current is supplied to the motor 5 to generate the large output torque, so that the amount of heat generation of the exciting coils 22 becomes large, and thereby some measures should be taken against the heat.

A first characteristic of the first embodiment will now be described in detail.

In order to address the disadvantages recited in the above sections (1) to (3), the shift range change device of the first embodiment adapts the following measures.

The SBW ECU 7 includes a torque increasing means for increasing an output torque of the motor 5 only at the time of parking release (the time of changing from P to notP) for releasing the engagement between the parking gear 43 and the park pole 44.

Specifically, the torque increasing means of the first embodiment include the following structure.

As described above, the motor 5 includes the exciting coils 22 of the first and second systems 22A, 22B.

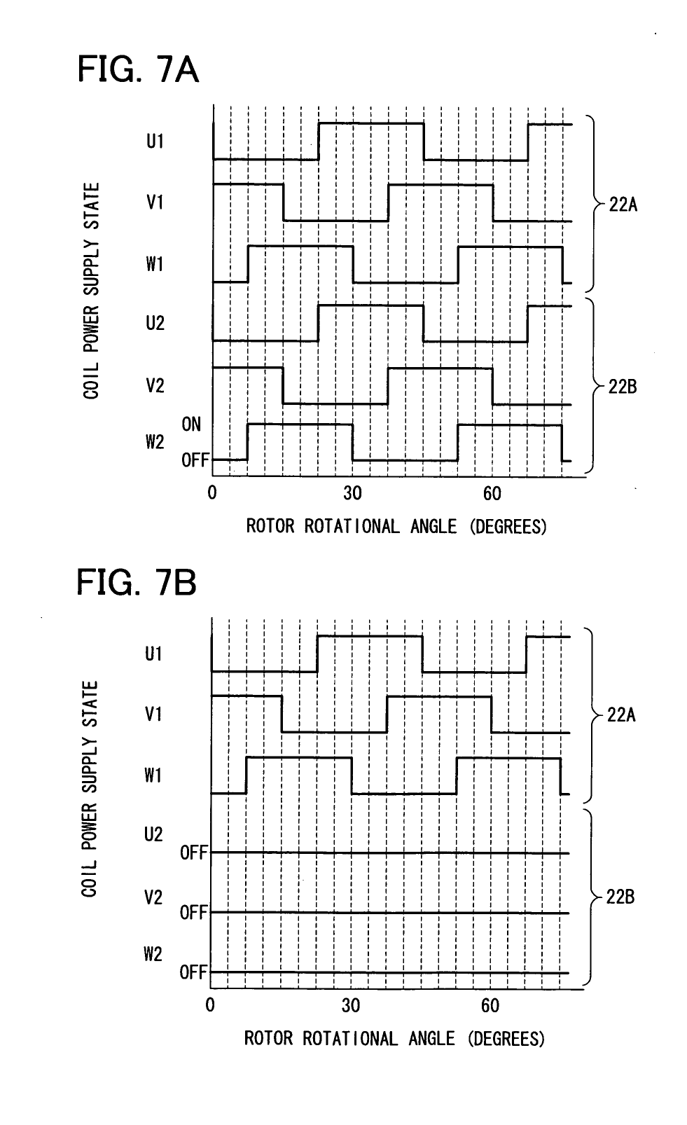

The SBW ECU 7 includes a control program, which implements the following processes. Specifically, as shown in FIG. 7A, only at the time of parking release, the SBW ECU 7 provides the electric power to both of the coils U1, V1, W1 of the first system 22A and the coils U2, V2, W2 of the second system 22B to increase the output torque of the motor 5. Then, as shown in FIG. 7B, at the time of the other operation (including the abutment control operation), which is other than the parking release, the SBW ECU 7 provides the electric power to only the coils U1, V1, W1 of the first system 22A (while stopping the power supply to the coils U2, V2, W2 of the second system 22B) to reduce the output torque of the motor 5.

Here, the control program may be modified such that, as shown in FIG. 8, the power supply is executed only to the coils U1, V1, W1 of the first system 22A through duty ratio control (while stopping the power supply to the coils U2, V2, W2 of the second system 22B) at the time of the other operation, which is other than the parking release, so that the output torque of the motor 5 is further reduced.

As discussed above, the first embodiment discloses the technique of stopping the power supply to the exciting coils of the one of the two systems. Alternatively, this may be modified as follows. That is, even in the case of the normal motor 5 having only the exciting coils of the one system (the motor 5 capable of executing the smooth parking release even upon parking the vehicle on the slope), the duty ratio control is used at the time of the other operation, which is other than the parking release, to limit the coil supply electric current to thereby reduce the output torque of the motor 5. Then, the duty ratio control may be stopped only at the time of the parking release to increase the coil supply electric current to increase the output torque of the motor 5.

When the above first characteristic of the first embodiment is adapted, the large output torque is not generated by the motor 5 at the time of the other operation, which is other than the parking release and does not require the large torque. Thus, it is possible to reduce the mechanical load torque on the components of the rotation transmission system as well as the engaging part between the movable member and the stationary member, which receive the output torque of the motor 5. Thereby, it is possible to limit the occurrence of the mechanical damage for a long period of time.

Furthermore, since it is possible to limit the power consumption of the motor 5 at the time of the other operation, which is other than the parking release, the power consumption of the shift range change apparatus can be reduced, and thereby the amount of heat generation at the motor 5 can be reduced to avoid a malfunction caused by the heat generation of the exciting coils 22. Specifically, the measures for addressing the trouble of the heat generation of the exciting coils 22 can be easily made, so that it is possible to limit the costs.

Specifically, when the first characteristic of the first embodiment is adapted, the disadvantages discussed in the above sections (1) to (3) can be addressed.

A second characteristic of the first embodiment will now be described.

The torque increasing means of the first embodiment adapts the following measures to further enhance the first characteristic of the first embodiment.

The SBW ECU 7 is constructed to receive a tilt signal, which indicates the tilt of the vehicle, from the vehicle tilt sensor 81, which senses the tilt of the vehicle. The tilt sensor 81 can sense at least a front-to-rear tilt angle of the vehicle. Furthermore, the vehicle tilt sensor 81 may continuously sense the tilt angle of the vehicle or may generate the signal after increasing of the tilt angle of the vehicle equal to or greater than a predetermined angle (e.g., five degrees or higher). The vehicle tilt sensor 81 may be the vehicle tilt sensor provided in the shift range change apparatus or may be the vehicle tilt sensor (e.g., a G sensor used in an ABS system) provided in the other preexisting device in the vehicle.

The control program of the SBW ECU 7 increases the output torque of the motor 5 proportionally or nonproportionally to the tilt angle of the vehicle at the time of the parking release for releasing the engagement between the parking gear 43 and the park pole 44 only when the tilt angle (specifically, at least the front-to-rear tilt angle of the vehicle) of the vehicle, which is sensed with the vehicle tilt sensor 81, is equal to or greater than the predetermined angle (e.g., the five degrees or higher).

When the second characteristic of the first embodiment is adapted, the motor 5 generates the large output torque only at the time of the parking release at the slope where the relatively large drive torque is required for the parking release. Thereby, the motor 5 does not generate the large output torque at the time of the parking release, which does not require the large torque, and at the time of the other operation, which is other than the parking release. Thus, with the first characteristic of the first embodiment, it is possible to reduce the mechanical load torque on the components of the rotation transmission system as well as the engaging part between the movable member and the stationary member, and it is also possible to reduce the power consumption of the shift range change apparatus and the amount of heat generation of the coils of the motor 5.

The first and second characteristics of the first embodiment can be implemented by partially modifying the program of the SBW ECU 7 while limiting the increase in the costs.

### Second Embodiment

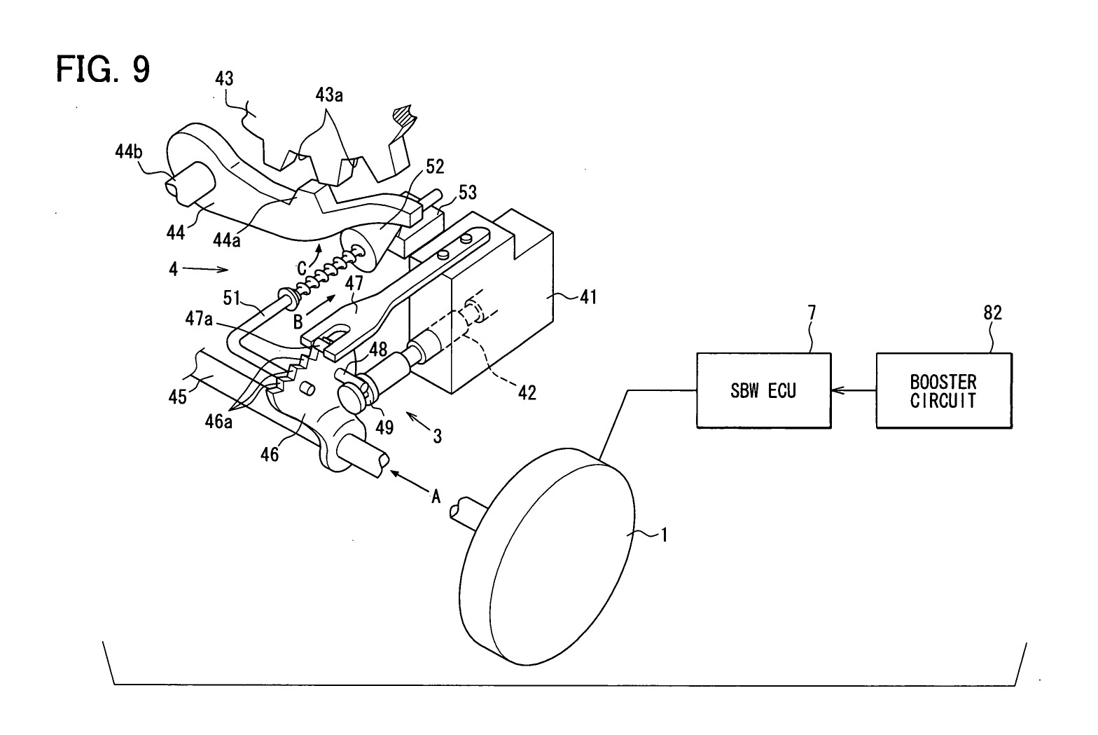

A second embodiment of the present invention will be described with reference to FIG. 9. In the following embodiments, components similar to those of the first embodiment will be indicated by the same reference numerals.

In the first embodiment, the motor 5 includes the exciting coils of the first and second systems 22A, 22B, and the power supply is provided to both of the first and second systems 22A, 22B only at the time of the parking release to increase the output torque generated from the motor 5.

However, the size of the motor 5 may be disadvantageously increased in the case where the exciting coils of the two systems are provided in the motor 5 to increase the output torque of the motor 5 only at the time of the parking release, which does not occur often.

The second embodiment adapts the following technique to address the above disadvantage.

The motor 5 of the second embodiment includes the exciting coils 22 of the single system and is thereby has the smaller size and the smaller weight in comparison to the first embodiment.

The shift range change apparatus has a booster circuit 82, which increases, i.e., boosts the voltage supplied from the battery 73 of the vehicle, and the SBW ECU 7 (specifically, the coil drive circuit 71 of the motor 5) is provided to receive the increased voltage from the booster circuit 82. The booster circuit 82 may be the booster circuit provided in the shift range change apparatus or may be the booster circuit provided in the other preexisting device of the vehicle.

The SBW ECU 7 provides the increased voltage, which is received from the booster circuit 82, to the motor 5 to increase the output torque of the motor 5 only at the time of the parking release for releasing the engagement between the parking gear 43 and the park pole 44.

When the second embodiment is adapted, the increased voltage, which is supplied from the booster circuit 82, is applied to the motor 5 only at the time of the parking release to increase the output torque of the motor 5. Therefore, in addition to advantages of the first characteristic of the first embodiment, it is possible to reduce the size and the weight of the motor 5 and to reduce the manufacturing costs of the rotatable actuator 1.

### Third Embodiment

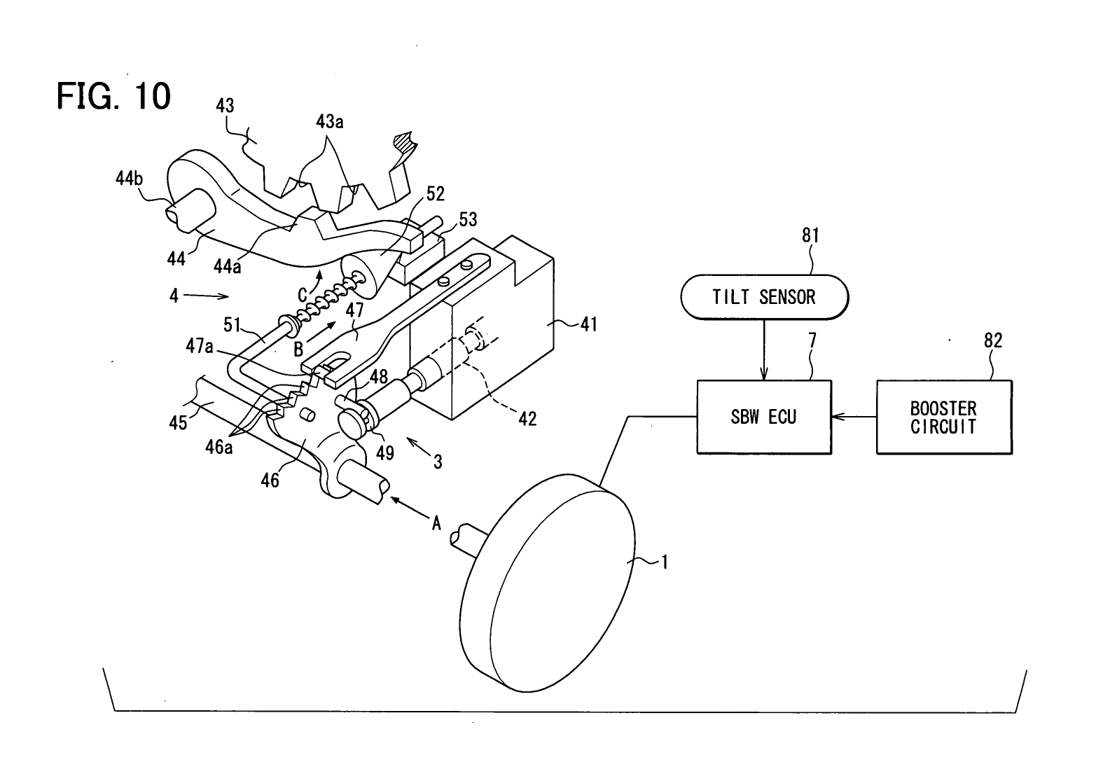

A third embodiment of the present invention will be described with reference to FIG. 10.

The third embodiment is a combination of the second characteristic of the first embodiment and the second embodiment.

The motor 5 of the third embodiment includes the exciting coils 22 of the single system and is thereby has the smaller size and the smaller weight in comparison to the first embodiment.

The SBW ECU 7 is constructed to receive a tilt signal, which indicates the tilt of the vehicle, from the vehicle tilt sensor 81, which senses the tilt of the vehicle. The vehicle tilt sensor 81 can sense at least the front-to-rear tilt angle of the vehicle and may be the vehicle tilt sensor provided in the shift range change apparatus or may be the vehicle tilt sensor (e.g., the G sensor used in the ABS system) provided in the other preexisting device in the vehicle.

The shift range change apparatus has the booster circuit 82, which increases the voltage supplied from the battery 73 of the vehicle, and the SBW ECU 7 (specifically, the coil drive circuit 71 of the motor 5) is provided to receive the increased voltage from the booster circuit 82. The booster circuit 82 may be the booster circuit provided in the shift range change apparatus or may be the booster circuit provided in the other preexisting device of the vehicle like the second embodiment.

The control program of the SBW ECU 7 increases the output torque of the motor 5 proportionally or nonproportionally to the tilt angle of the vehicle at the time of the parking release for releasing the engagement between the parking gear 43 and the park pole 44 only if the tilt angle of the vehicle, which is sensed with the vehicle tilt sensor 81, is equal to or greater than the predetermined angle (e.g., the five degrees or higher).

When the third embodiment is adapted, the increased voltage, which is supplied from the booster circuit 82, is applied to the motor 5 to increase the output torque of the motor 5 only at the time of the parking release in the parked state of the vehicle on the slope. Thereby, in addition to the advantages of the second embodiment, the advantages of the first characteristic of the first embodiment can be achieved. Specifically, the large output torque is generated from the motor 5 by supplying the increased voltage to the motor 5 only at the time of the parking release on the slope where the large drive torque is particularly required for the parking release. In contrast, the motor 5 does not generate the large output torque at the time of the parking release, which does not require the large torque (e.g., the time of the parking release on the flat road with no tilt) and at the time of the other operation (including the abutment control operation), which is other than the parking release. Therefore, in comparison to the first characteristic of the first embodiment, it is possible to further reduce the mechanical load torque on the components of the rotation transmission system as well as the engaging part between the movable member and the stationary member, and the power consumption of the shift range change apparatus as well as the amount of the heat generation at the coils of the motor 5 can be reduced. Also, the size and the weight of the motor 5 can be reduced, and the manufacturing costs of the rotatable actuator 1 can be reduced.

Now, modifications of the above embodiments will be described.

In the above embodiments, the encoder 60 is illustrated as the specific example. However, the encoder 60 may be eliminated, and the number of times of power supply (energization) of the respective exciting coils 22 may be counted to control the number of rotations per unit time and the rotational angle of the rotor 11. Alternatively, an output angle sensor, which senses the angle of the output shaft 17 of the speed reducer 6, may be used to recognize (identify) the current shift range.

In the above embodiments, the SR motor is illustrated as the example of the motor 5. Alternatively, the motor 5 may be any other suitable motor, such as another reluctance motor (e.g., a synchronous reluctance motor), a permanent magnet motor (e.g., a surface permanent magnet (SPM) motor, an interior permanent magnet (IPM) motor).

In the above embodiments, the inner gearing planetary gear speed reducer (the cycloid speed reducer) is illustrated as the example of the speed reducer 6. Alternatively, the speed reducer 6 may be another type of planetary gear speed reducer, which includes the sun gear 26 driven by the rotor shaft 13, a plurality of planetary pinions arranged one after another at equal intervals about the sun gear 26, and a ring gear meshed with the planetary pinions.

In the above embodiments, the inner gearing planetary gear speed reducer (the cycloid speed reducer) is illustrated as the example of the speed reducer 6. Alternatively, the speed reducer 6 may be another speed reducer, which includes the sun gear 26 driven by the rotor shaft 13, and a plurality of gear trains meshed with the sun gear 26.

Additional advantages and modifications will readily occur to those skilled in the art. The invention in its broader terms is therefore not limited to the specific details, representative apparatus, and illustrative examples shown and described.

What is claimed is:

1. A shift range change apparatus comprising:
a shift range change mechanism that changes a shift range of an automatic transmission of a vehicle;
a parking change mechanism that disables rotation of a drive axle of the vehicle by engaging a park pole supported by a stationary member against a parking gear, which is rotated synchronously with the drive axle of the vehicle, at time of setting the shift range to parking, wherein the parking change mechanism enables the rotation of the drive axle by disengaging the park pole from the parking gear at time of parking release of the shift range;
an electric rotatable actuator that drives the shift range change mechanism and the parking change mechanism; and
a motor control means for controlling power supply to an electric motor of the rotatable actuator, wherein the motor control means includes a torque increasing means for increasing an output torque of the electric motor only at the time of the parking release.

2. The shift range change apparatus according to claim 1, wherein:
the torque increasing means is adapted to receive a vehicle tilt signal from a vehicle tilt sensor, which senses a tilt of the vehicle; and
the torque increasing means increases the output torque of the electric motor only when a tilt angle of the vehicle indicated by the vehicle tilt single is equal to or higher than a predetermined angle at the time of the parking release.

3. The shift range change apparatus according to claim 1, wherein:
the torque increasing means is adapted to receive an increased voltage from a booster circuit, which increases a battery voltage of a battery of the vehicle; and
the torque increasing means increases the output torque of the electric motor by applying the increased voltage, which is received from the booster circuit, to the electric motor only at the time of the parking release.

4. The shift range change apparatus according to claim 1, wherein:
the torque increasing means is adapted to receive a vehicle tilt signal from a vehicle tilt sensor, which senses a tilt of the vehicle, and is also adapted to receive an increased voltage from a booster circuit, which increases a battery voltage of a battery of the vehicle; and
the torque increasing means increase the output torque of the electric motor by applying the increased voltage, which is received from the booster circuit, to the electric motor only when a tilt angle of the vehicle indicated by the vehicle tilt single is equal to or higher than a predetermined angle at the time of the parking release.
